(19) United States
(12) Patent Application Publication
(10) Pub. No.: US 2003/0179592 A1
(43) Pub. Date: Sep. 25, 2003

(54) DC/DC converter and method for controlling same

(75) Inventors: Tomohiro Nishiyama, Tokyo (JP); Yoshinao Naitou, Tokyo (JP); Kouji Takada, Tokyo (JP); Masuo Hanawaka, Tokyo (JP); Seiichi Noguchi, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: YOKOGAWA ELECTRIC CORPORATION, Tokyo (JP)

(21) Appl. No.: 10/262,887

(22) Filed: Oct. 3, 2002

(30) Foreign Application Priority Data
Mar. 25, 2002 (JP) 2002-083508

(51) Int. Cl. H02M 3/335

(52) U.S. Cl. 363/20

(57) ABSTRACT

The object of the present invention is to provide a DC/DC converter and a method for controlling the DC/DC converter whereby losses under light loads are reduced.

The present invention relates to improvements made to DC/DC converters in which a main switching device intermittently turns on power from a power supply to the primary winding of a voltage-converting transformer, and an active clamp circuit configured by at least series-connecting a capacitor and a sub-switching device is parallel-connected to the primary winding. The DC/DC converter comprises a first controller for turning the main switching device on and off according to the difference between the output voltage of said DC/DC converter and a desired output voltage and a second controller for turning on the sub-switching device for a desired length of time after the turning off of the main switching device.

### BACKGROUND OF THE INVENTION

1. Field of the Invention

The present invention relates to a DC/DC converter having an active clamp circuit and a method for controlling the DC/DC converter and, more particularly, to a DC/DC converter and a method for controlling the DC/DC converter whereby losses under light loads are reduced.

2. Description of the Prior Art

In a switching power supply or other power supply systems, a DC/DC converter is used as a device for isolatedly converting a DC input voltage to feed power to a load circuit. The DC/DC converters configured for such purposes are classified into the forward and flyback types depending on the difference in polarity between the primary and secondary windings of an isolation transformer. Examples of forward DC/DC converters are the converters disclosed in the U.S. Pat. Nos. 4,441,146 and 4,959,764. Now, such a device as mentioned above is shown in FIG. 1 and described.

In FIG. 1, a symbol V11 denotes a DC input power supply, symbols C11, C12, C13 and C21 denote capacitors, symbols Q11 and Q12 denote switching devices, symbols D11, D12, D21 and D22 denote diodes, symbols Np and Ns denote windings, a symbol L21 denotes a coil, a symbol Lr denotes a leakage inductance, a symbol A denotes an error amplifier, and symbols CTL11 and CTL12 denote controllers. The capacitor C13 and switching device Q12 form an active clamp circuit, whereas the windings Np and Ns form a transformer T1 and the D21 and D22 form a rectifying circuit.

The positive-voltage side of the DC input power supply V11 is connected to one end of the capacitor C13 and one end of the winding Np. At this point, the leakage inductance Lr of the transformer T1 develops across those ends of the capacitor C13 and winding Np. The other end of the capacitor C13 is connected to one end of the switching device Q12. The winding Np is a primary winding, the other end of which is connected to one end of the switching device Q11. The switching device Q12 is a sub-switching device, the other end of which is connected to one end of the switching device Q11. The switching device Q11 is a main switching device, the other end of which is connected to the negative-voltage side of the DC input power supply V11.

The cathodes of the diodes D11 and D12 are respectively connected to one end each of the switching devices Q11 and Q12. The anodes of the diodes D11 and D12 are respectively connected to the other ends of the switching devices Q11 and Q12. The capacitors C11 and C12 are parallel-connected to the switching devices Q11 and Q12, respectively. The diode D11, capacitor C11 and switching device Q11 form a MOSFET, wherein one end of the switching device Q11 serves as the drain and the other end as the source. Likewise, the diode D12, capacitor C12 and switching device Q12 form a MOSFET, wherein one end of the switching device Q12 serves as the drain and the other end as the source.

The winding Ns is a secondary winding, one end of which is connected to the anode of the diode D21 and the other end is connected to the anode of the diode D22. The diode D21 is a forward rectifier, the cathode of which is connected to one end of the coil L21. The diode D22 is a fly-wheel rectifier, the cathode of which is connected to one end of the coil L21. The coil L21 is an inductance device, the other end of which is connected to one end of the capacitor C21. The capacitor C21 is a smoothing capacitor, the other end of which is connected to the other end of the winding Ns. The negative end of the error amplifier A is connected to one end of the capacitor C21 and the positive end is connected to the other end of the capacitor C21 through a voltage reference (desired output voltage). Thus, the amplifier outputs a feedback signal which is the difference between the output voltage of the DC/DC converter and the desired output voltage.

The controllers CTL11 and CTL12 turn on and off the switching devices Q11 and Q12, respectively.

Next, specific examples of the configurations of the controllers CTL11 and CTL12 are shown in FIG. 2 and described. The controller CTL11 is composed of an oscillator 11, a pulse width modulation (PWM) circuit 12, a delay circuit 13, and a driver 14. The oscillator 11 outputs an oscillation frequency signal. The PWM circuit 12 outputs a PWM signal according to the oscillation frequency signal from the oscillator 11 and the feedback signal from the error amplifier A. The delay circuit 13 delays the PWM signal of the PWM circuit 12. The driver 14 is given the output of the delay circuit 13, so that the driver turns on and off the switching device Q11. Each of these circuit elements is grounded to the negative-voltage side of the DC input power supply V11.

The controller CTL12 is composed of a delay circuit 21, a level shift circuit 22, and a driver 23. The delay circuit 21 is grounded to the negative-voltage side of the DC input power supply V11 and delays the PWM signal of the PWM circuit 11. The level shift circuit 22 is grounded to the negative-voltage side of the DC input power supply V11 and the other end of the switching device Q12. Thus, the level shift circuit 22 outputs a signal whose level is shifted to a high voltage, according to the output of the delay circuit 21 and the PWM signal of the PWM circuit 12. The driver 23 is grounded to the other end of the switching device Q12, and given the output of the level shift circuit 22 so that the driver turns on and off the switching device Q12.

Now, such a DC/DC converter as explained above is described by first referring to the general behavior thereof. The controllers CTL11 and CTL12 alternately turn on and off the switching devices Q11 and Q12, wherein a dead time is set in order to prevent the switching devices from turning on at the same time.

As indicated by a solid-line arrow in FIG. 1, a current flows through the diode D21 during the period wherein the switching device Q11 is on and the switching device Q12 is off. This current causes another current to be supplied to a load, which is not shown in the figure, and energizes the secondary-side coil L21 so that energy is stored therein.

During the period before the switching device Q11 turns off and switching device Q12 turns on, the current flowing through the diode D21 decreases and the current flowing through the diode D22 increases.

As indicated by a dashed-line arrow in FIG. 1, a current flows through the diode D22 during the period wherein the switching device Q11 is off and the switching device Q12 is on, because of the energy stored in the coil L21.

During the period before the switching device Q12 turns off and switching device Q11 turns on, the current flowing through the diode D22 decreases and the current flowing through the diode D21 increases.

Next, behaviors of the controllers CTL11 and CTL12 are described by first explaining their behaviors under a normal load, using FIG. 3. FIG. 3 is a timing chart showing the behavior of the DC/DC converter of FIG. 2 under a normal load. In FIG. 3, a symbol (a) denotes the drain-source voltage Vds of the switching device Q11, a symbol (b) denotes the drain-source current Ids of the switching device Q11, a symbol (c) denotes the drain-source voltage Vds of the switching device Q12. a symbol (d) denotes the drain-source current Ids of the switching device Q12, a symbol (e) denotes the gate-source voltage Vgs of the switching device Q11, i.e., the output of the driver 14, a symbol (f) denotes the output of the oscillator 11, a symbol (g) denotes the output of the PWM circuit 12, a symbol (h) denotes the output of the delay circuit 13, a symbol (i) denotes the gate-source voltage Vgs of the switching device Q12, i.e., the output of the driver 23, a symbol (j) denotes the output of the delay circuit 21, and a symbol (k) denotes the output of the level shift circuit 22.

At a time t0, the output of the oscillator 11 goes high. The PWM circuit 12 outputs a high-state signal when the feedback signal of the error amplifier A is high. This output signal causes the level shift circuit 22 to output a low-state signal. This output signal causes the driver 23 to turn on the switching device Q12.

At a time t1, the delay circuit 13 causes the PWM circuit 12 to output a delayed signal, lest the main switching device Q11 and the sub-switching device Q12 turn on at the same time. The output of the delay circuit 13 causes the driver 14 to turn on the switching device Q11.

At a time t2, the PWM circuit 12 inverts the signal thereof and outputs the signal to the delay circuits 13 and 21 and the level shift circuit 23 when a pulse width appropriate for the voltage of the feedback signal of the error amplifier A is reached. The signal of the delay circuit 21 rises when the signal of the PWM circuit 12 falls, lest the switching devices Q11 and Q12 turn on at the same time.

At a time t3, the output of the driver 14 goes low when the delay circuit 13 inverts the output thereof, thus turning off the switching device Q11. The delay circuit 21 remains high with the signal thereof kept delayed.

At a time t4, the signal of the delay circuit 21, when inverted, is amplified by the driver 23 so as to turn on the switching device Q12. The switching device Q12 remains on until the PWM circuit 12 inverts the output thereof once again (at a time t5).

Next, the behavior of the DC/DC converter under a light load is described by referring to FIG. 4. FIG. 4 is a timing chart showing the behavior of the DC/DC converter of FIG. 2 under a light load. In FIG. 4, a symbol (a) denotes the gate-source voltage Vgs of the switching device Q11, i.e., the output of the driver 14, a symbol (b) denotes the gate-source voltage Vgs of the switching device Q12, i.e., the output of the driver 23, a symbol (c) denotes the feedback signal of the error amplifier A, a symbol (d) denotes the output of the oscillator 11, a symbol (e) denotes the output of the PWM circuit 12, a symbol (f) denotes the output of the delay circuit 13, a symbol (g) denotes the output of the delay circuit 21, and a symbol (h) denotes the output of the level shift circuit 22.

During the period from a time t0 to a time t1, the switching device Q11 is prohibited from turning on when the feedback signal from the error amplifier A is low, even if the signal of the oscillator 11 is input to the PWM circuit 12. When the switching device Q11 becomes unable to turn on, a voltage is kept applied to the gate of the sub-switching device Q12, thus causing the sub-switching device Q12 to remain on. At this point, the clamp capacitor C13 and the leakage inductance Lr of the transformer T1 produce resonance, causing electricity stored in the capacitor C13 to discharge.

At a time t1, if a signal is input from the oscillator 11 to the PWM circuit 12 when the feedback signal is high, the output signal of the PWM circuit 12 is inverted. Consequently, a signal is input to the level shift circuit 22 and therefore the switching device Q12 turns off. Concurrently, the signal from the PWM circuit 12 is input to the delay circuit 13. Then, after a given delay, the switching device Q11 is turned on by the driver 14.

At a time t2, the signal of the PWM circuit 12 reaches a pulse width appropriate for the feedback signal of the error amplifier A, and is inverted. Following the inversion, the delay circuit 13 also inverts the signal thereof after a given delay, so that the switching device Q11 is turned off by the driver 14 and therefore the capacitor C13 is charged. Concurrently, the signal of the PWM circuit 12 is input to the delay circuit 21, causing the signal thereof to rise.

At a time t3, the delay circuit 21 inverts the output signal thereof after a delay from the rise of the output so as not to cause the switching devices Q11 and Q12 to turn on at the same time. The output of the delay circuit 21 causes the level shift circuit 22 to invert the signal thereof, so that the switching device Q12 is turned off by the driver 23. At a time t4, the DC/DC converter goes back to the state existing at the time t0.

This means that under a light load, the DC/DC converter goes into intermittent oscillation wherein the main switching device Q11 is at a stop for a certain period because of the response characteristics of feedback control. Since the sub-switching device Q12 remains on during the period wherein the switching device Q11 is at a stop, electricity charged into the clamp capacitor C13 is discharged because of resonance produced by the capacitor C13 and the leakage inductance Lr. Consequently, the amount of energy of 0.5 CV²f (C=capacitance of capacitor C13, V=voltage applied to capacitor C13, and f=output frequency of oscillator 11) is consumed as a loss.

For environmental reasons, there is a need to reduce the energy loss of electronic equipment, particularly to reduce the loss in the stand-by state of such equipment. Although the DC/DC converter with an active clamp circuit goes into intermittent oscillation under a light load, the sub-switching device Q12 remains on even if the main switching device Q11 turns off. This results in the problem that electricity stored in the clamp capacitor C13 is discharged and therefore large losses are unavoidable.

### SUMMARY OF THE INVENTION

The object of the present invention is to provide a DC/DC converter and a method for controlling the DC/DC converter whereby losses under light loads are reduced.

### BRIEF DESCRIPTION OF THE DRAWINGS

FIG. 1 is a circuit diagram of a prior art DC/DC converter.

FIG. 2 is a circuit diagram showing the main elements of the prior art DC/DC converter.

FIG. 3 is a timing chart showing the behavior of the DC/DC converter shown in FIG. 2.

FIG. 4 is another timing chart showing the behavior of the DC/DC converter shown in FIG. 2.

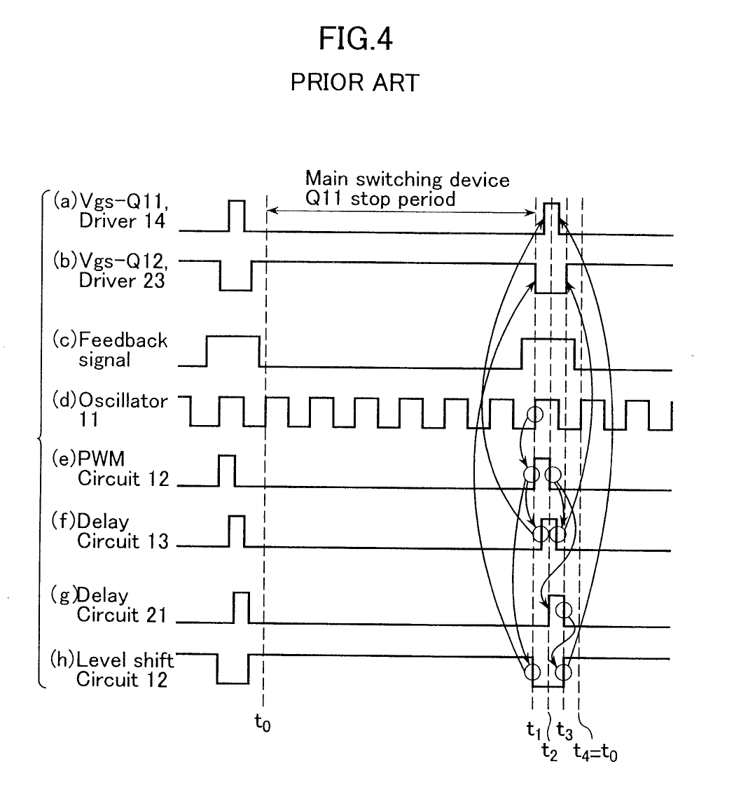

FIG. 5 is a circuit diagram showing the first embodiment of the present invention.

FIG. 6 is a timing chart showing the behavior of the DC/DC converter in FIG. 5 under a normal load.

FIG. 7 is a timing chart showing the behavior of the DC/DC converter in FIG. 5 under a light load.

FIG. 8 is a circuit diagram showing the second embodiment of the present invention.

FIG. 9 is a circuit diagram showing the third embodiment of the present invention.

FIG. 10 is a circuit diagram showing the fourth embodiment of the present invention.

FIG. 11 is a circuit diagram showing the fifth embodiment of the present invention.

FIG. 12 is a circuit diagram showing the sixth embodiment of the present invention.

FIG. 13 is a circuit diagram showing the seventh embodiment of the present invention.

### DETAILED DESCRIPTION OF THE PREFERRED EMBODIMENTS

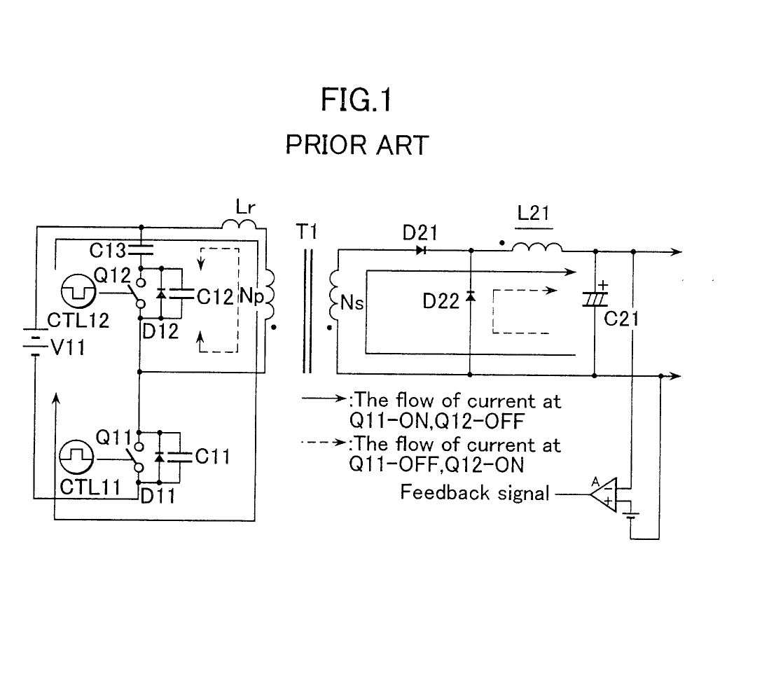

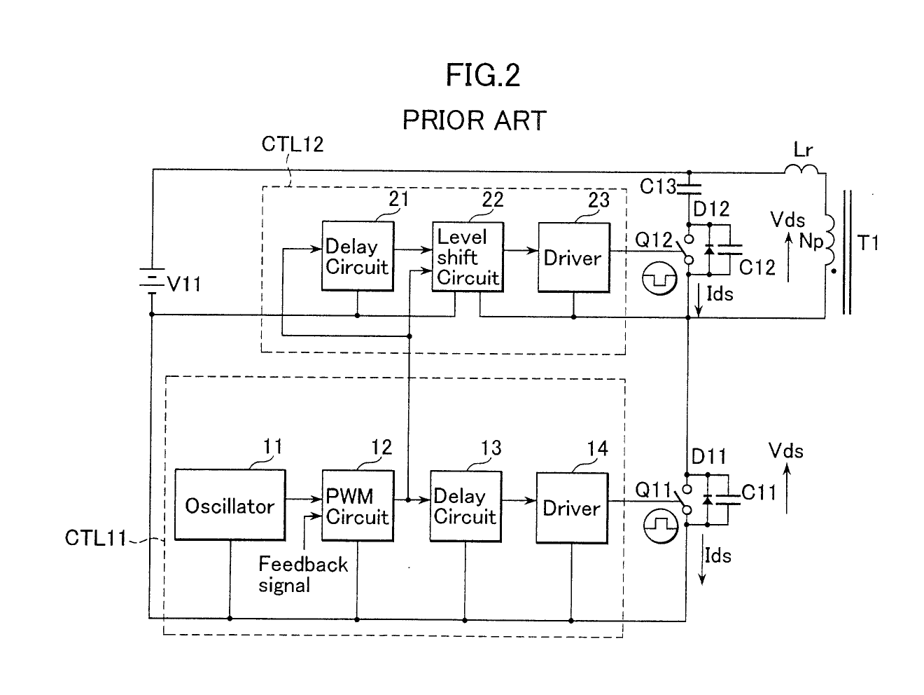

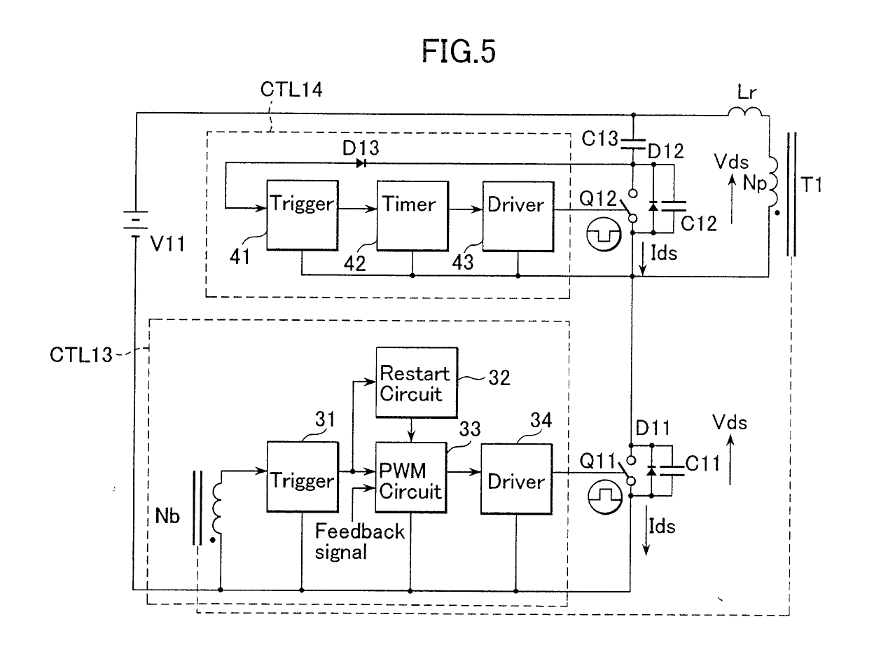

Preferred embodiments of the present invention will now be described in detail by referring to the accompanying drawings. FIG. 5 is a circuit diagram showing the first embodiment of the present invention and main elements therein. Note that elements identical to those shown in FIG. 1 or FIG. 2 are referenced alike and excluded from the description.

In FIG. 5, a first controller CTL13 turns on and off a main switching device Q11 according to the feedback signal of an error amplifier A. A second controller CTL14 keeps a switching device Q12 turned on for a desired period after the main switching device Q11 is turned off.

The controller CTL13 comprises an auxiliary winding Nb, a trigger 31, a restart circuit 32, a PWM circuit 33, and a driver 34. The auxiliary winding Nb is provided in a transformer T1, and one end of the winding is connected to the negative-voltage side of a DC input power supply V11, in order to detect a voltage change in a winding Np. The trigger 31 is connected to the other end of the auxiliary winding Nb, in order to detect the turning off of the sub-switching device Q12 by means of a voltage change in the auxiliary winding Nb and output a trigger signal. The restart circuit 32 is reset by the trigger signal of the trigger 31, and outputs a restart signal each time a given length of time (fixed length of time in this embodiment) elapses. The PWM circuit 33 outputs a PWM signal according to the trigger signal of the trigger 31, the restart signal of the restart circuit 32, and the feedback signal of the error amplifier A. The driver 34 is given the PWM signal of the PWM circuit 33, in order to turn on and off the switching device Q11. Each of these circuit elements is grounded to the negative-voltage side of the DC input power supply V11.

The controller CTL14 comprises a diode D13, a trigger 41, a timer 42, and a driver 43. The cathode of the diode D13 is connected between the capacitor C13 and the switching device Q12. The trigger 41 is connected to the anode of the diode D13, and outputs a trigger signal. The timer 42 is a pulse-width circuit and is given the trigger signal of the trigger 41 to set a desired pulse width. The driver 43 is given the output of the timer 42, in order to turn on and off the switching device Q12. Each of these circuit elements is grounded to the other end of the switching device Q12.

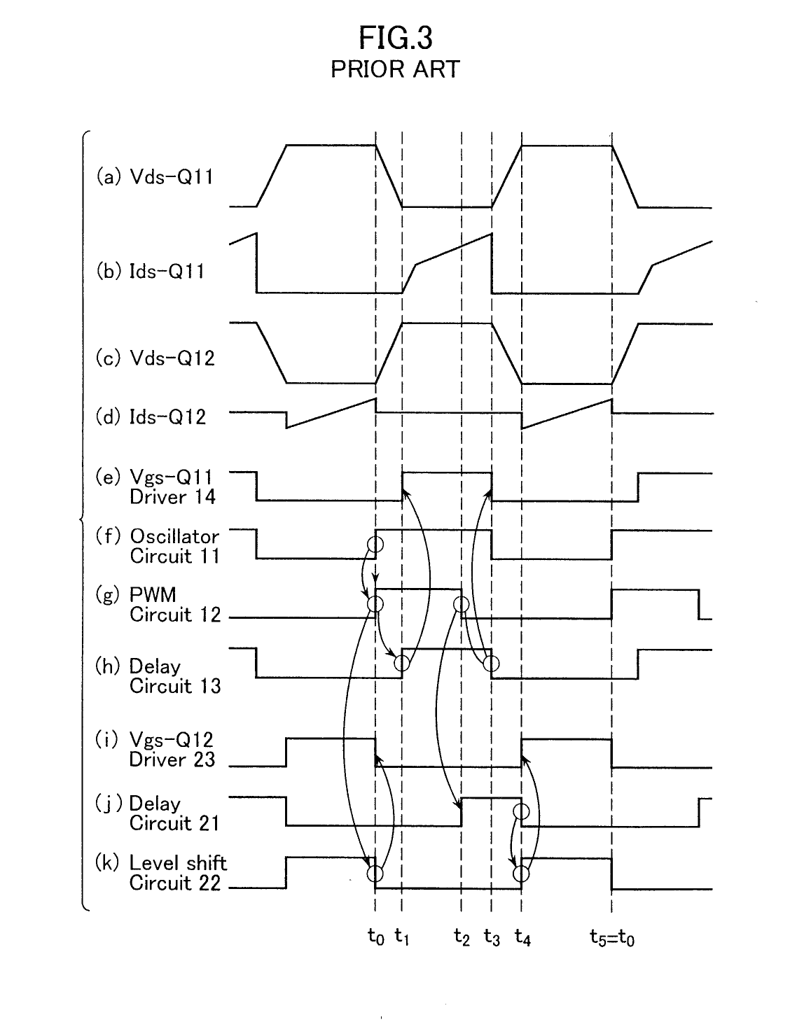

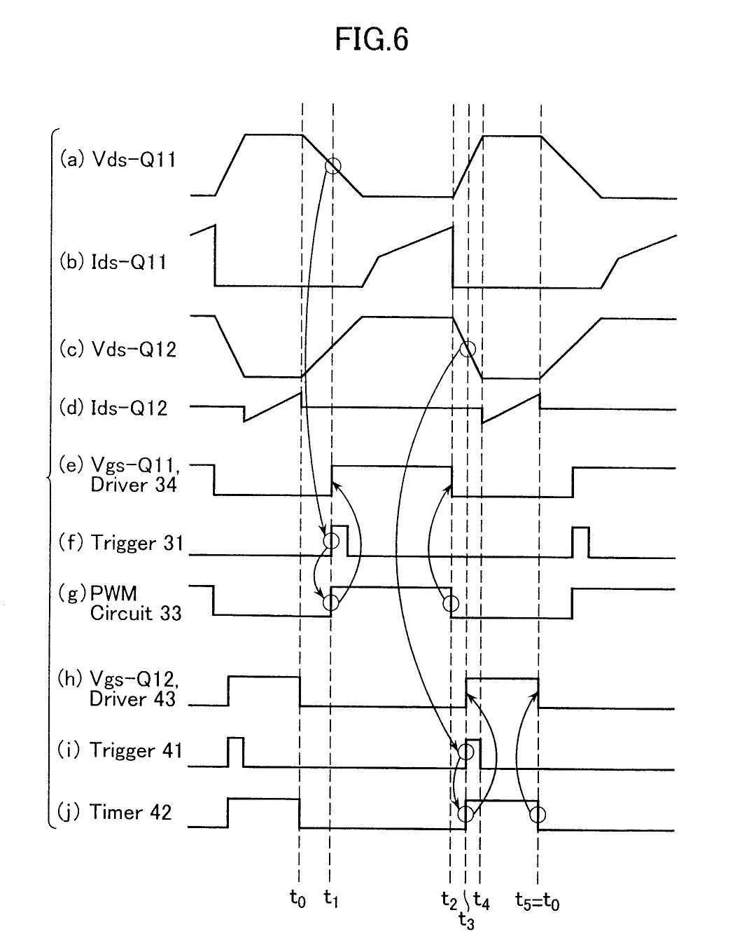

Now, such a DC/DC converter as explained above is described. Note that the general behavior of the DC/DC converter is the same as that of the prior art DC/DC converter, and is therefore not described here. Firstly, the converter's behavior under a normal load is described by referring to FIG. 6. FIG. 6 is a timing chart showing the behavior of the DC/DC converter of FIG. 5 under a normal load. In FIG. 6, symbols (a) to (d) denote the same signals as those denoted in FIG. 3. A symbol (e) denotes the gate-source voltage Vgs of the switching device Q11. i.e., the output of the driver 34, a symbol (f) denotes the output of the trigger 31, a symbol (g) denotes the output of the PWM circuit 33, a symbol (h) denotes the gate-source voltage Vgs of the switching device Q12, i.e., the output of the driver 43, a symbol (i) denotes the output of the trigger 41, and a symbol (j) denotes the output of the timer 42.

At a time t0 the flow of a current in the winding Np reverses and the voltage of the auxiliary winding Nb is inverted when the sub-switching device Q12 turns off. This means that the drain-source voltage of the switching device Q12 is inverted and begins to rise. The rise in the drain-source voltage Vds of the switching device Q12 is input to the trigger 31 through the winding Np and auxiliary winding Nb.

At a time t1, the voltage of the auxiliary winding Nb exceeds a given level, causing the trigger 31 to output a trigger signal (oneshot pulse signal). This trigger signal causes the PWM circuit 33 to invert the signal thereof and output the signal to the driver 34. Then, the driver 34 amplifies the signal to turn on the main switching device Q11.

At a time t2 after the switching device Q11 turns on, the PWM circuit 33 inverts the preset PWM signal according to the magnitude of the feedback signal from the error amplifier A, so that the output of the DC/DC converter is kept constant. Consequently, the driver 34 zeroes the output thereof and turns off the switching device Q11. When the switching device Q11 is turned off, the drain-source voltage the switching device Q12 begins to decrease.

At a time t3, the trigger 41 detects a drop in the drain-source voltage of the switching device Q12 through the diode D13, and outputs a trigger signal (oneshot pulse signal). The signal is amplified by the driver 43 through the timer 42 to turn on the switching device Q12.

At a time t4, the trigger signal of the trigger 41 terminates, but the timer 42 continues to provide the output thereof.

At a time t5, when a given length of the on-state period of the switching device Q12 elapses, the timer 42 expires and zeroes the output thereof. Consequently, the driver 43 also zeroes the output thereof and turns off the switching device Q12.

This means that the switching devices Q11 and Q12 on the primary side operate in self-excited oscillation mode wherein the devices turn on by detecting the operating waveform of the DC/DC converter.

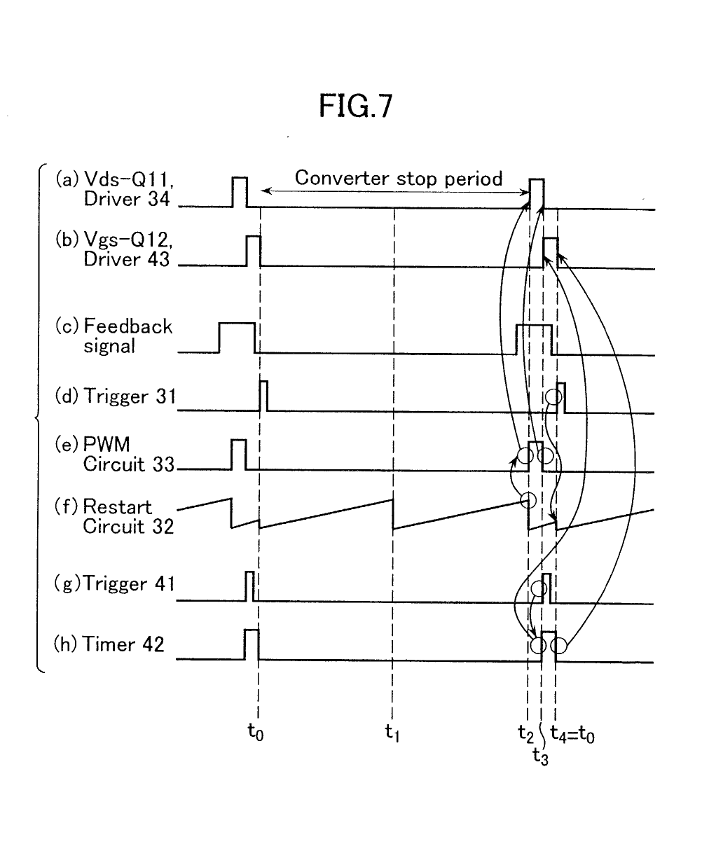

Next, the converter's behavior under a light load is described by referring to FIG. 7. FIG. 7 is a timing chart showing the behavior of the DC/DC converter of FIG. 5 under a light load. In FIG. 7, a symbol (a) denotes the gate-source voltage Vgs of the switching device Q11, i.e., the output of the driver 34, a symbol (b) denotes the gate-source voltage Vgs of the switching device Q12, i.e., the output of the driver 43, a symbol (c) denotes the feedback signal of the error amplifier A, a symbol (d) denotes the output of the trigger 31, a symbol (e) denotes the output of the PWM circuit 33, a symbol (f) denotes the lapse of time in the restart circuit 32, a symbol (g) denotes the output of the trigger 41, and a symbol (h) denotes the output of the timer 42.

At a time t0, the PWM circuit 33 does not provide any output even if the trigger 31 outputs a trigger signal, since the feedback signal of the error amplifier A is low. The restart circuit 32 is reset by the trigger signal and resumes timer operation.

At a time t1, the restart circuit 32 expires, outputs a restart signal, and resumes timer operation once again. The restart signal is input to the PWM circuit 33, but no feedback signal is input thereinto from the error amplifier A. Therefore, the PWM circuit 33 does not provide any PWM signal.

At a time t2, the restart circuit 32 expires once again, outputs a restart signal, and resumes timer operation once again. The restart signal is input to the PWM circuit 33, and a feedback signal is also input thereinto from the error amplifier A. Therefore, the PWM circuit 33 provides a PWM signal. With input of the PWM signal, the driver 34 turns on the switching device Q11. Consequently, the DC/DC converter is enabled once again.

At a time t3, the PWM circuit 33 sets an on-state period according to the magnitude of the feedback signal from the error amplifier A, so that the output of the DC/DC converter is kept constant. When the on-state period expires, the PWM circuit 33 inverts the signal being output. The signal thus inverted causes the driver 34 to turn off the switching device Q11. Consequently. the drain-source voltage of the switching device Q12 decreases, causing the trigger 41 to output a trigger signal. This trigger signal causes the driver 43 to turn on the switching device Q12 through the timer 42.

At a time t4, when the timer 42 expires, the driver 43 turns off the switching device Q12.

The above-described DC/DC converter has the following advantages.

(1) The controller CTL14 detects the turning off of the main switching device Q11 according to a voltage change in the drain-source voltage of the sub-switching device Q12, and keeps the sub-switching device Q12 turned on for a desired period. This means that the sub-switching device Q12 does not turn on as long as the main switching device Q11 is at a stop. Consequently, energy stored in the clamp capacitor C13 is not consumed and, therefore, operation with reduced losses can be achieved.

Furthermore, by ensuring that the sub-switching device Q12 is always brought into action after the main switching device Q11 has already come into action, it is possible to always feed excitation energy, which is produced as the result of the main switching device Q11 being enabled, into the clamp capacitor C13. Consequently, an active clamp action is taken in any sort of operation and, therefore, the withstanding voltage of each circuit element is never exceeded.

(2) The system is based on a self-excitation method wherein trigger signals are derived from the internal operating waveform of the DC/DC converter by means of the triggers 31 and 41. Consequently, there is no need for a circuit for disabling the sub-switching device Q12 when the system is under a light load. Furthermore, the system does not require any dead-time circuit for preventing the switching devices Q11 and Q12 from turning on at the same time.

(3) The controllers CTL13 and CTL14 are grounded at different potentials and operate independently of each other. Consequently, there is no need for any complex level shift circuit or high-voltage circuit, thus simplifying the converter's circuitry. Among other circuit elements, the driver 43 for the switching device Q12 does not require any commonly used high-voltage driver IC or pulse transformer. Consequently, it is possible to configure small-sized, inexpensive converter circuitry.

(4) In cases where the auxiliary winding Nb of the transformer T1 is used, the auxiliary winding can also be used as a winding for supplying power to the controller CTL13. Consequently, it is possible to reduce the size and cost of the DC/DC converter.

(5) The controllers CTL13 and CTL14 are based on a self-excited control method. This means that when an input power supply wherein an AC power supply output is rectified and smoothed is used, the oscillation frequency varies as the rectified and smoothed voltage varies. Consequently, noise is decentralized and therefore the level of electromagnetic interference (EMI) noise is reduced.

Now, other embodiments will be described below.

### 1) Second Embodiment

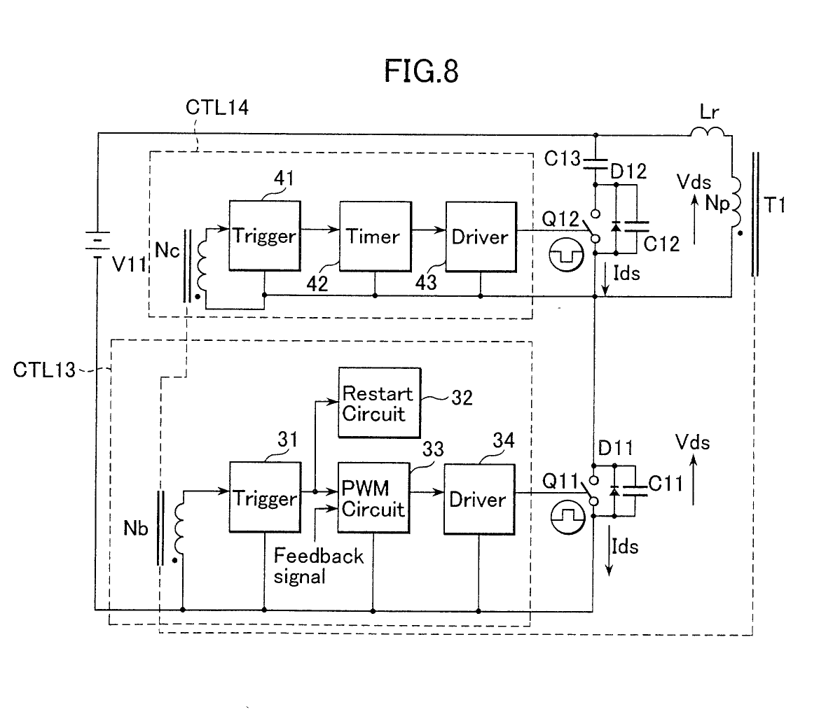

FIG. 8 is a circuit diagram showing a second embodiment of the present invention. Note that elements identical to those shown in FIG. 5 are referenced alike and excluded from the description. In FIG. 8, an auxiliary winding Nc is provided in the transformer T1 in place of the diode D13. One end of the auxiliary winding Nc is grounded to detect a voltage change in the winding Np, and the other end is connected to the input of the trigger 41.

The behavior of the DC/DC converter thus configured is basically the same as that of the system shown in FIG. 5. This DC/DC converter differs from that of FIG. 5 only in that the trigger 41 outputs a trigger signal by means of a voltage change in the winding Np through the auxiliary winding Nc, whereas the trigger outputs a trigger signal by means of a change in the drain-source voltage of the switching device Q12 through the diode D13 in the DC/DC converter of FIG. 5.

### 2) Third Embodiment

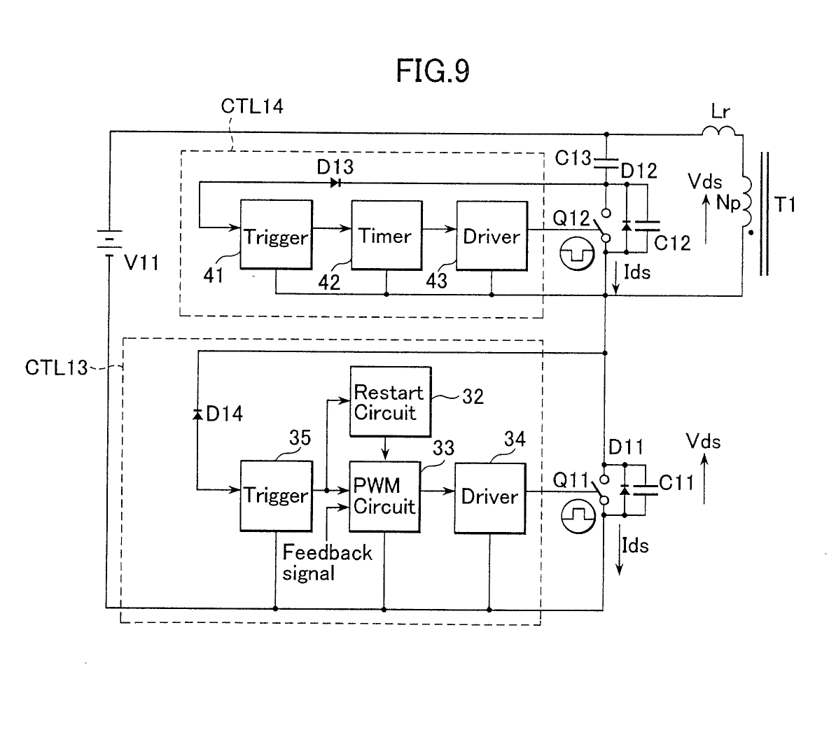

FIG. 9 is a circuit diagram showing a third embodiment of the present invention. Note that elements identical to those shown in FIG. 5 are referenced alike and excluded from the description. In FIG. 9, a diode D14 is provided in place of the auxiliary winding Nb. The cathode of the diode D14 is connected to one end of the switching device Q11. A trigger 35 is provided in place of the trigger 31 and connected to the anode of the diode D14. The trigger 35 outputs a trigger signal to the restart circuit 32 and PWM circuit 33, and is grounded to the negative-voltage side of the DC input power supply V11.

The behavior of the DC/DC converter thus configured is basically the same as that of the DC/DC converter shown in FIG. 5. This DC/DC converter differs from the system of FIG. 5 only in that the trigger 35 outputs a trigger signal by means of a voltage change in the drain-source voltage of the switching device Q11 through the diode D14, whereas the trigger 31 outputs a trigger signal by means of a voltage change in the winding Np in the DC/DC converter of FIG. 5.

### 3) Fourth Embodiment

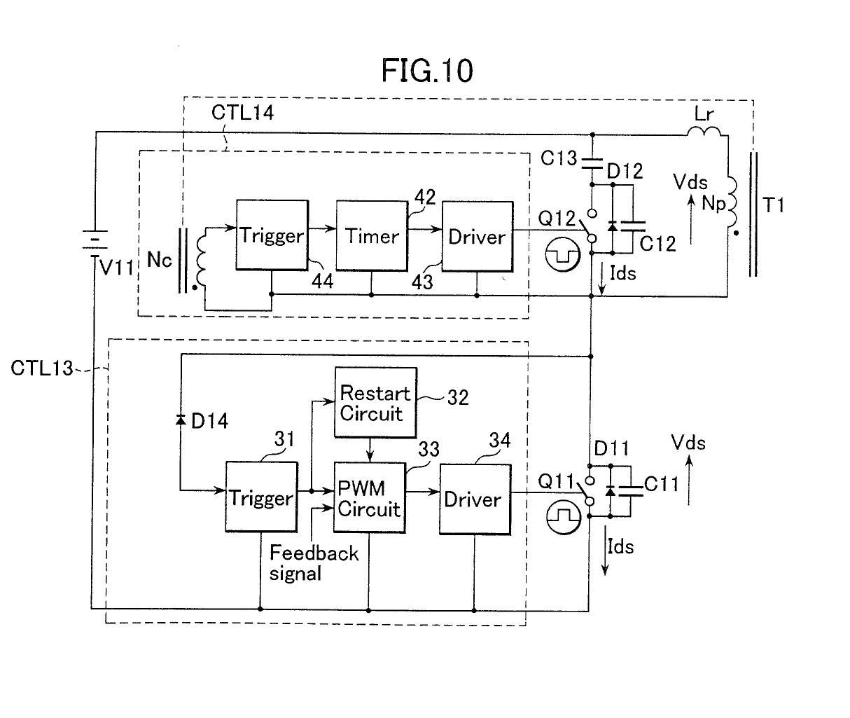

FIG. 10 is a circuit diagram showing a fourth embodiment of the present invention. The DC/DC converter of FIG. 10 is the result of combining changes made to the DC/DC converter of FIG. 5 so as to obtain the DC/DC converters of FIGS. 8 and 9. In FIG. 10, an auxiliary winding Nc is provided in the transformer T1 in place of the diode D13. One end of the auxiliary winding Nc is grounded to detect a voltage change in the winding Np, and the other end is connected to the input of the trigger 41. A diode D14 is provided in place of the auxiliary winding Nb. The cathode of the diode D14 is connected to one end of the switching device Q11. A trigger 35 is provided in place of the trigger 31 and connected to the anode of the diode D14. The trigger 35 outputs a trigger signal to the restart circuit 32 and PWM circuit 33, and is grounded to the negative-voltage side of the DC input power supply V11.

Although the DC/DC converter differs in behavior from the DC/DC converter of FIG. 5, the difference is the same as in the case of the DC/DC converters shown in FIGS. 8 and 9, and therefore will not be explained here.

### 4) Fifth Embodiment

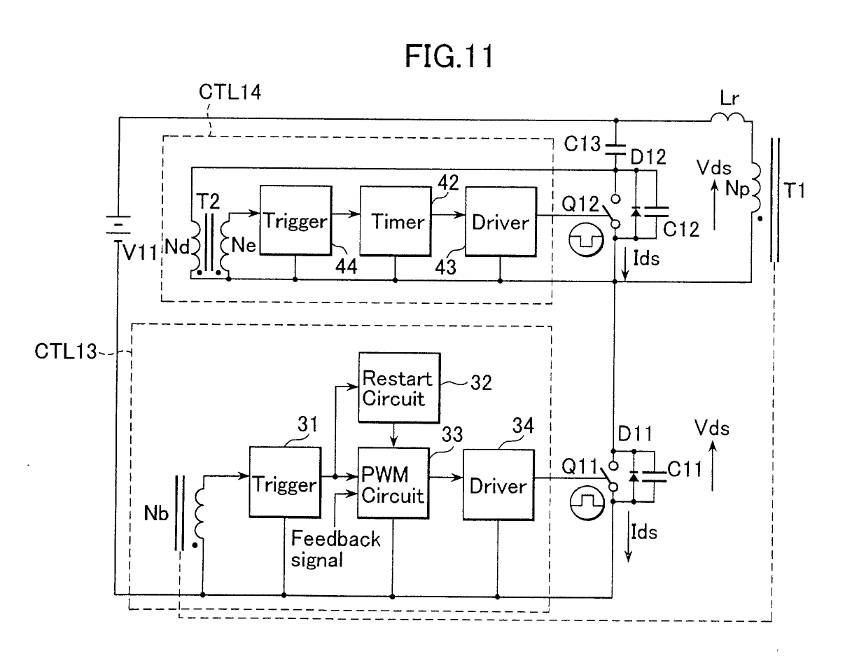

FIG. 11 is a circuit diagram showing a fifth embodiment of the present invention. Note that elements identical to those shown in FIG. 5 are referenced alike and excluded from the description. In FIG. 11, an auxiliary transformer T2 is equipped with windings Nd and Ne in place of the diode D13, detects a voltage change in the primary winding Np, and provides isolation. One end of the winding Nd is connected to one end of the switching device Q12 and the other end is connected to the other end of the switching device Q12. One end of the winding Ne is connected to the other end of the switching device Q12. A trigger 44 is provided in place of the trigger 41 and connected to the other end of the winding Ne, and outputs a trigger signal to a timer 42. The trigger 44 is grounded to the other end of the switching device Q12.

The behavior of the DC/DC converter thus configured is basically the same as that of the DC/DC converter shown in FIG. 5. This DC/DC converter differs from that of FIG. 5 only in that the trigger 44 outputs a trigger signal by means of a voltage change in the drain-source voltage of the switching device Q12 through the auxiliary transformer T2.

It should be noted that the present invention is in no way limited to the first to fifth embodiments. The polarities of the windings Nb, Nc, Nd and Ne may be such as can be handled more easily by triggers.

Although reference is made to a DC/DC converter configured using the diodes D13 and D14, changes in the drain-source voltages of the switching device Q11 and Q12 may be detected within the triggers 35 and 41 without the need for the diodes D13 and D14.

Furthermore, the DC/DC converter may be configured using the controller CTL11 shown in FIG. 2 in place of the controller CTL13. More particularly, the DC/DC converter may be configured so that the controller CTL14 turns off the sub-switching device Q12 under a light load.

Furthermore, the controller CTL13 may be configured using an auxiliary transformer in place of the winding Nb. It is also possible for the auxiliary transformer T2 to use a potential at one end of the switching device Q11 or at one end of the primary winding Np, as long as a voltage change in the primary winding Np can be detected. Note that when a potential at one end of the switching device Q11 is used, the other end of the winding Nd is connected to the other end of the switching device Q11.

Although further reference is made to a DC/DC converter configured using the auxiliary windings Nb and Nc and the auxiliary transformer T2 within the controllers CTL13 and CTL14, the windings and transformer may be provided outside the controllers.

Although a MOSFET is shown as the switching device, capacitors and diodes may be added if a regular switch is used instead of the switching device.

### 5) Sixth Embodiment

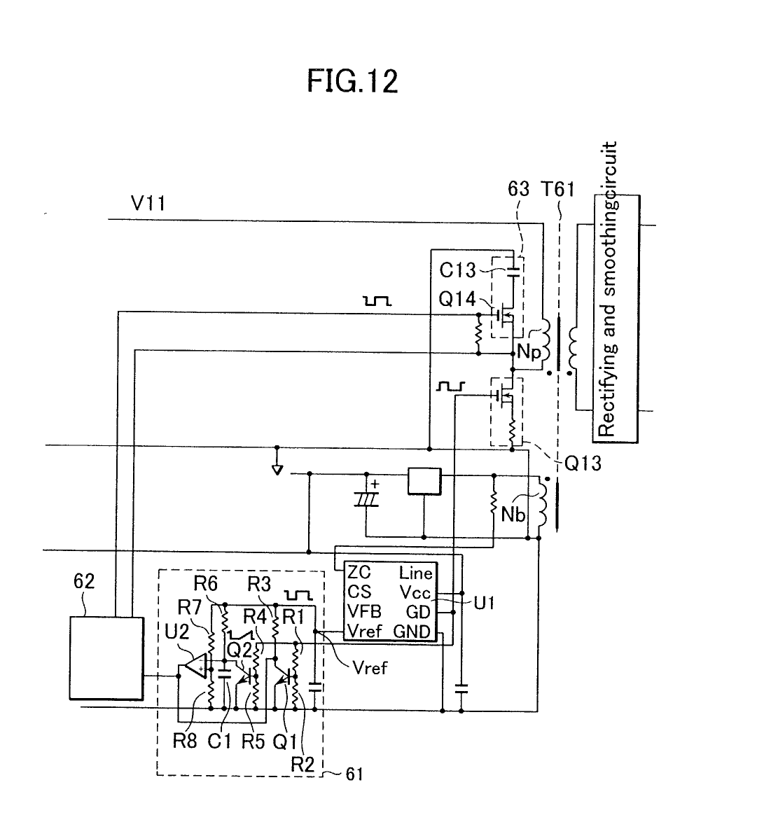

FIG. 12 is a circuit diagram showing the sixth embodiment of the present invention.

A transformer T61 comprises a primary winding Np and an auxiliary winding Nb. A main switching device Q13 is placed in series with the primary winding Np. By turning the main switching device Q13 on and off, power from a power supply V11 is transferred to the secondary stage of the transformer T61. In this embodiment, the main switching device Q13 is comprised of a MOSFET and a resistor added to the source thereof and is connected to a common potential point through the resistor.

A voltage is produced in the first auxiliary winding Nb when the primary winding Np turns on. This voltage is rectified and smoothed to obtain a given voltage and the voltage is used as a power supply to a controller, which is discussed later.

An active clamp circuit 63 consists of a sub-switching device Q14, which is a MOSFET, and a capacitor C13, wherein one end of the capacitor C13 is connected to one end (drain) of the sub-switching device Q14. Another end (source) of the sub-switching device 14 is connected to one end (drain) of the main switching device Q13, and the other end of the capacitor C13 is connected to another end (common potential point) of the main switching device Q13. In other words, the main switching device Q13 and the active clamp circuit 63 are connected in parallel with each other.

Even in this circuit configuration, the high-frequency equivalent circuit of this embodiment is still the same as in the case of the active clamp circuit 63 being connected in parallel with the primary winding Np. Consequently, the same active clamp action as discussed earlier is taken and, therefore, the withstanding voltage of each circuit element is never exceeded.

A first controller U1, when given an input of a feedback signal (not shown in the figure) from the output of the DC/DC converter, performs on/off-control of the main switching device Q13 using a PWM-modulated control signal GD, so that errors with reference to a preset voltage value are eliminated.

Note that the first controller U1 produces a trigger signal internally by means of an input of voltage from the auxiliary winding Nb, when the voltage changes and exceeds a given level, and uses the trigger signal as the reference for control operation.

A second controller consists of a pulse width circuit 61 and a driver 62. The pulse width circuit 61 sets the output of the driver 62 to a low state and thereby turns off the sub-switching device Q14, when the control signal GD of the first controller U1 is high (main switching device Q13 is on).

When the control signal GD goes low (main switching device Q13 is off), the pulse width circuit 61 outputs a pulse width signal for a preset length of time, sets the output of the driver 62 to a high state, and thereby keeps the sub-switching device Q14 turned on for a given length of time.

More particularly, the control signal GD of the first controller U1, after being voltage-divided by resistors R1 and R2 and by resistors R4 and R5, is applied to the bases of transistors Q1 and Q2.

The collector of the transistor Q1 is connected to the input of the driver 62 and pulled up to a reference potential point Vref by means of a resistor R3 and the emitter of the transistor Q1 is connected to the common potential point. Consequently, a low-state voltage (voltage at the common potential point) is applied to the input of the driver 62 when the transistor Q1 is on, and a high-state voltage (voltage at the reference potential point Vref) is applied thereto when the transistor Q1 is off.

The collector of the transistor Q2 is connected to one end of a resistor R6, one end of a capacitor C1, and the inverting input of a comparator U2. The other end of the resistor R6 is connected to the reference potential point Vref, and the other end of the capacitor C1 is connected to the common potential point. The voltage at the reference potential point Vref is divided by means of resistors R7 and R8, and applied to the non-inverting input of the comparator U2. Consequently, a low-state voltage is applied to the inverting input of the comparator U2 when the transistor Q2 turns on, and electricity stored in the capacitor C1 are discharged. At this point, a high-state voltage is output to the output end of the comparator U2. When transistor Q2 turns off, the capacitor C1 is charged into through the resistor R6. When the voltage at the inverting input of the comparator U2 becomes higher than the voltage at the non-inverting input thereof, the output of the comparator U2 goes low. Consequently, a pulse width signal with a preset width is produced at the output of the comparator U2.

The driver 62 is given an input of the output signal of the comparator U2. This input, when at a high-state voltage, turns on the sub-switching device Q14 and, when at a low-state voltage, turns off the device. Note that in order to perform the on/off control of the sub-switching device Q14, which is a MOSFET, by means of a change in the gate-source voltage thereof, the driver 62 is configured so as to drive the system at different levels of the control signal.

As explained above, it is possible to keep the sub-switching device Q14 turned on for a desired length of time when the main switching device Q13 turns off.

Note that an alternating voltage produced across the first auxiliary winding Nb of the transformer T61 may be used as an input signal to the pulse width circuit 61.

In another aspect of the present invention, a trigger, which detects that the main switching device Q13 has turned off and generates a trigger signal by means of the control signal GD or a voltage change in the auxiliary winding Nb of the transformer T61, may be added in front of the pulse width circuit 61. In this case, the pulse width circuit is configured using a monostable multivibrator or the like that produces a one-shot pulse with a given width according to the abovementioned trigger signal.

### 6) Seventh Embodiment

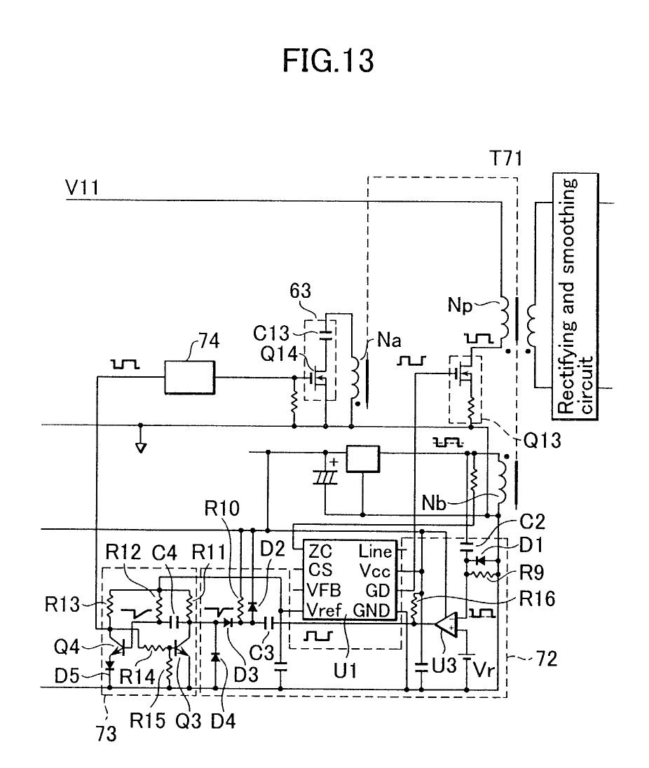

FIG. 13 is a circuit diagram showing the seventh embodiment of the present invention.

In FIG. 13, elements identical to those shown in earlier figures are referenced alike and excluded from the following explanation.

A transformer T71 is such that an auxiliary winding Na is added to the primary side of the transformer T61 in the sixth embodiment. A primary winding Np and an auxiliary winding Nb function in the same way as those of the sixth embodiment.

In this embodiment, an active clamp circuit 63 is connected in parallel with the auxiliary winding Na of the transformer T71. The high-frequency equivalent circuit of this system configuration is equivalent to the circuit of a system configuration where the active clamp circuit 63 is arranged in parallel with the primary winding Np, as long as the leakage inductance of the transformer T71 is negligible. Consequently, the same active clamp action as discussed earlier is taken and, therefore, the withstanding voltage of each circuit element is never exceeded.

A second controller is comprised of a trigger 72, a pulse width circuit 73, and a driver 74.

The trigger 72 detects by means of a voltage change in the auxiliary winding Nb of the transformer T71 that the main switching device Q13 has turned off, and generates a trigger signal.

More specifically, one end of a capacitor C2 is connected to the auxiliary winding Nb of the transformer T72, and the cathode of a diode D1 and one end of a resistor R9 are connected to the other end of the capacitor C2. The anode of the diode Dl and the other end of the resistor R9 are connected to a common potential point. An alternating voltage (negative when the main switching device Q13 is on and positive when the device is off) produced across the auxiliary winding Nb is rectified, is converted to a signal having high and low states, and is applied to the inverting input of a comparator U3. A reference voltage Vr is applied to the non-inverting input of the comparator U3, and the waveform of the signal thus input is inverted, shaped and then output. In this case, the reference voltage Vr serves as a threshold for waveform shaping.

The output of the comparator U3 is connected to one end of a capacitor C3, and the anode of a diode D2, one end of a resistor R10, and the cathode of a diode D3 are connected to the other end of this capacitor. A power supply voltage is applied to the cathode of the diode D2 and the other end of the resistor R10. The anode of the diode D3 is connected to the cathode of a diode D4, the anode of which is connected to the common potential point.

Consequently, a differential circuit is formed, and a trigger signal appropriate for the falling edge of the comparator U3's output signal (whereby the main switching device Q13 is turned off) is generated at a point where the anode of the diode D3 and the cathode of the diode D4 are connected.

The pulse width circuit 73, when given an input of this trigger signal, generates a pulse width signal with a preset duration.

More specifically, the collector of the transistor Q3, one end of a capacitor C4, and one of a resistor R11 are connected to one another, and the output signal of the trigger 72 is applied to the connection point.

One end of a resistor R12 and the base of a transistor Q4 are connected to the other end of the capacitor C4, and one end of a resistor R13 is connected to the collector of the transistor Q4. A voltage divider is formed by resistors R14 and R15, divides the collector voltage of the transistor Q4, and applies the divided voltage to the base of the transistor Q13. The other ends of the resistors R11, R12 and R13 are pulled up to the reference potential point Vref of the first controller. The emitter of the transistor Q4 is connected to the anode of the diode D5, the cathode of which and the emitter of the transistor Q3 are connected to the common potential point. Consequently, a monostable multivibrator is formed and, when a trigger signal is input, a pulse width signal with a preset duration is output from the collector of the transistor Q4.

A driver 74 turns on the sub-switching device Q14 when the pulse width signal being input from the pulse width circuit 73 is in a high state, and turns off the device when the signal is in a low state.

Note that it is also possible to base the reference of the driver 74's output signal upon the common potential point by connecting the source of the sub-switching device Q14, which is a MOSFET, to the common potential point. This strategy eliminates the need for driving the sub-switching device Q14 by changing the level of the control signal, thus simplifying the circuit configuration.

As explained heretofore, it is possible to keep the sub-switching device Q14 turned on for a desired length of time when the main switching device Q13 turns off.

Note that the control signal GD of the first controller U1 may be used as an input signal to the trigger 72, instead of a voltage provided by the auxiliary winding Nb of the transformer T71, in order to detect that the main switching device Q13 has turned off and generate a trigger signal.

In yet another aspect of the present invention, this trigger may be omitted and the control signal GD or the voltage of the auxiliary winding Nb may be directly input to the pulse width circuit. In this case, the pulse width circuit should have the same configuration as that applied in the sixth embodiment.

Also note that the on/off action of the main switching device Q13 causes the drain voltage amplitude of the device to increase up to several hundreds volts. This results in noise being generated through the stray capacitance of peripheral circuitry. Consequently, a malfunction will result if the common potential point shared by the trigger and pulse width circuit is used as the reference for the drain voltage of the main switching device Q13.

In contrast, the common potential point shared by the trigger and pulse width circuit can be set at the same potential as that of the first controller U1, as discussed in the sixth or seventh embodiment, in order to stabilize the operation of these circuit elements. This means that it is possible to prevent these circuits' elements from malfunctioning due to switching noise arising from the main switching device Q13.

In yet another aspect of the present invention, a step-up type DC/DC converter can be formed by using the transformer in this embodiment as an inductor to rectify and smooth the drain voltage of the main switching device Q13. Thus, the system of the present invention may be applied to a DC/DC converter having this configuration.

In yet another aspect of the present invention, the system may be configured so that the common potential points of the first and second controllers share the same potential for a case where the active clamp circuit 63 is connected in parallel with the primary winding Np of the transformer.

Consequently, by turning on the sub-switching device for a desired length of time when the main switching device turns off, as discussed earlier, it is possible to reduce losses without consuming energy stored in the capacitor. It is also possible to stabilize the operation of circuit elements, such as the trigger and pulse width circuit, contained in the second controller.

The second controller detects the turning off of the main switching device by means of a voltage change in the sub-switching device and keeps the sub-switching device turned on for a desired length of time. Consequently, the sub-switching device never turns on as long as the main switching device remains quiescent. Thus, it is possible to reduce losses without consuming energy stored in the capacitor.

Since the second controller detects the turning off of the main switching device from the operating waveform internal to the converter, there is no need for a circuit for disabling the sub-switching device under a light load. Furthermore, there is no need for such a dead time circuit as to prevent the main switching device and sub-switching device from turning on simultaneously.

The first and second controllers have different ground potentials and operate independently. Consequently, there is no need for any complex level shifter or high-voltage circuitry and, therefore, the system can have simple circuitry.

The first and second controllers are based on self-excited control. Consequently, when a power supply wherein a supply of AC power is rectified and smoothed is used, the oscillation frequency changes due to fluctuations in the rectified and smoothed voltage, electric noise disperses, and thus the level of EMI noise lowers.

Since the controllers are powered by the auxiliary winding of the transformer, it is possible to downsize the DC/DC converter and reduce the costs thereof.

The turning off of the main switching device is detected by means of a voltage change in the sub-switching device and the sub-switching device is kept turned on for a desired length of time. Consequently, the sub-switching device never turns on as long as the main switching device remains quiescent. Thus, it is possible to reduce losses without consuming energy stored in the capacitor.

As discussed heretofore, the present invention offers the following advantages.

According to claim 1 or 2 of the present invention, the turning off of the main switching device is detected by means of a voltage change in the sub-switching device and the sub-switching device is kept turned on for a desired length of time. Consequently, the sub-switching device never turns on as long as the main switching device remains quiescent. Thus, it is possible to reduce losses without consuming energy stored in the capacitor.

According to claim 3 of the present invention, the turning off of the main switching device is detected by means of a voltage change in the sub-switching device and the sub-switching device is kept turned on for a desired length of time. Consequently, the sub-switching device never turns on as long as the main switching device remains quiescent. Thus, it is possible to reduce losses without consuming energy stored in the capacitor. Furthermore, by setting the common potential points of both the first and second controllers at the same potential, it is possible to reduce the effect of switching noise arising from the main switching device and, therefore, prevent malfunctions.

Another advantage is that the first controller for controlling the main switching device and the second controller for controlling the sub-switching device can be integrated into a single controller.

According to claim 4 or 5 of the present invention, by setting the common potential point of at least the pulse width circuit at the same potential as that of the first controller's common potential point, it is possible to reduce the effect of switching noise arising from the main switching device and, therefore, prevent malfunctions.

Another advantage is that the first controller for controlling the main switching device and the second controller for controlling the sub-switching device can be integrated into a single controller.

According to claim 6 of the present invention, by setting the common potential point of at least the trigger and the pulse width circuit at the same potential as that of the first controller's common potential point, it is possible to reduce the effect of switching noise arising from the main switching device and, therefore, prevent malfunctions.

Another advantage is that the first controller for controlling the main switching device and the second controller for controlling the sub-switching device can be integrated into a single controller.

According to claim 7 or 8 of the present invention, the turning off of the main switching device is detected by means of a voltage change in the sub-switching device and the sub-switching device is kept turned on for a desired length of time. Consequently, the sub-switching device never turns on as long as the main switching device remains quiescent. Thus, it is possible to realize a method for controlling the DC/DC converter whereby losses can be reduced without consuming energy stored in the capacitor.

According to claim 9 of the present invention, a step-up type DC/DC converter is formed by replacing the transformer with an inductor. Also in this system configuration, the turning off of the main switching device is detected by means of a voltage change in the sub-switching device and the sub-switching device is kept turned on for a desired length of time. Consequently, the sub-switching device never turns on as long as the main switching device remains quiescent. Thus, it is possible to realize a method for controlling the DC/DC converter whereby losses can be reduced without consuming energy stored in the capacitor.

What is claimed is:

1. A DC/DC converter in which a main switching device intermittently turns on power from a power supply to the primary winding of a voltage-converting transformer and which includes an active clamp circuit configured by at least series-connecting a capacitor and a sub-switching device, said DC/DC converter comprising:
a first controller for turning on and off said main switching device according to the difference between the output voltage of said DC/DC converter and a desired output voltage; and
a second controller for turning on said sub-switching device for a desired length of time after the turning off of said main switching device,
wherein said active clamp circuit is parallel-connected to said main switching device.

2. A DC/DC converter in which a main switching device intermittently turns on power from a power supply to the primary winding of a voltage-converting transformer and which includes an active clamp circuit configured by at least series-connecting a capacitor and a sub-switching device, said DC/DC converter comprising:
a first controller for turning on and off said main switching device according to the difference between the output voltage of said DC/DC converter and a desired output voltage; and
a second controller for turning on said sub-switching device for a desired length of time after the turning off of said main switching device,
wherein a first auxiliary winding is provided on the primary side of said transformer and said active clamp circuit is parallel-connected to said first auxiliary winding.

3. A DC/DC converter in which a main switching device intermittently turns on power from a power supply to the primary winding of a voltage-converting transformer and which includes an active clamp circuit configured by at least series-connecting a capacitor and a sub-switching device, said DC/DC converter comprising:
a first controller for turning on and off said main switching device according to the difference between the output voltage of said DC/DC converter and a desired output voltage; and
a second controller for turning on said sub-switching device for a desired length of time after the turning off of said main switching device,
wherein said active clamp circuit is parallel-connected to the primary winding of said transformer and the common potential points of said first controller and said second controller are set at the same potential.

4. The DC/DC converter of claim 1, 2 or 3, wherein said second controller comprises:
a pulse width circuit for outputting a pulse signal, according to the control signal of said main switching device, whereby said sub-switching device is kept turned on for said desired length of time after the turning off of said main switching device; and
a driver for driving said sub-switching device according to said pulse signal,
wherein the common potential point of at least said pulse width circuit and the common potential point of said first controller are set at the same potential.

5. The DC/DC converter of claim 1, 2 or 3, wherein said transformer further includes a second auxiliary winding on the primary side thereof and said second controller comprises:
a pulse width circuit for outputting a pulse signal, according to a voltage produced across said second auxiliary winding,
whereby said sub-switching device is kept turned on for said desired length of time; and
a driver for driving said sub-switching device according to said pulse signal,
wherein the common potential point of at least said pulse width circuit and the common potential point of said first controller are set at the same potential.

6. The DC/DC converter of claim 4 or 5, wherein a trigger, which detects that said main switching device has turned off and outputs a trigger signal according to the control signal of said main switching device or a voltage produced across said second auxiliary winding, is provided in front of said pulse width circuit; said pulse width circuit generates said pulse signal according to said trigger signal; and the common potential point of at least said trigger and said pulse width circuit and the common potential point of said first controller are set at the same potential.

7. A method for controlling a DC/DC converter in which a main switching device intermittently turns on power from a power supply to the primary winding of a voltage-converting transformer and which includes an active clamp circuit configured by at least series-connecting a capacitor and a sub-switching device is parallel-connected to said main switching device, wherein said sub-switching device is kept turned on for a desired length of time after the turning off of said main switching device.

8. A method for controlling a DC/DC converter in which a main switching device intermittently turns on power from a power supply to the primary winding of a voltage-converting transformer and which includes an active clamp circuit configured by at least series-connecting a capacitor and a sub-switching device is parallel-connected to an auxiliary winding provided on the primary side of said transformer, wherein said sub-switching device is kept turned on for a desired length of time after the turning off of said main switching device.

9. The DC/DC converter or the method for controlling said DC/DC converter as defined in any of claims 1 to 8, wherein an inductor is provided in place of said transformer.
